(19) United States
(12) Patent Application Publication
(10) Pub. No.: US 2024/0178706 A1
(43) Pub. Date: May 30, 2024

(54) POWER FOR VEHICLES TRAVELING ON OR ABOVE ROADS

(71) Applicant: Stuart Alexander Jacobson, San Francisco, CA (US)

(72) Inventor: Stuart Alexander Jacobson, San Francisco, CA (US)

(21) Appl. No.: 18/525,807

(22) Filed: Nov. 30, 2023

Related U.S. Application Data
(60) Provisional application No. 63/385,595, filed on Nov. 30, 2022.

(51) Int. Cl. H02J 50/80; H02J 7/00; H02J 7/14; H02J 50/60

(52) U.S. Cl. CPC H02J 50/80; H02J 7/00045; H02J 7/1446; H02J 50/60; H02J 2310/10; H02J 2310/48; H02J 2310/70

(57) ABSTRACT

Systems and techniques are provided for power delivery to vehicles on a roadway. A vehicle can be detected traveling on a roadway having a plurality of power distribution units for providing electrical power. The vehicle is authenticated to receive electrical power from one or more power distribution units based on identifying information associated with the vehicle. Based on successful authentication of the vehicle, a selected one or more power distribution units can be energized, the selected one or more power distribution units selected from the plurality of power distribution units as being nearest to the authenticated vehicle. Electrical power can be provided from at least one of the energized power distribution units to the authenticated vehicle while the authenticated vehicle travels along the roadway. The selected one or more power distribution units can be de-energized based on detecting that a load associated with the authenticated vehicle is no longer present.

### CROSS-REFERENCE TO RELATED APPLICATIONS

This application claims the benefit of priority to U.S. Provisional Patent Application No. 63/385,595 filed Nov. 30, 2022, and entitled “POWER FOR VEHICLES TRAVELING ON OR ABOVE ROADS,” the disclosure of which is herein incorporated by reference in its entirety and for all purposes.

### TECHNICAL FIELD

The present disclosure relates generally to electric-powered vehicles and delivery of electric power to vehicles while traveling.

### BACKGROUND

Electric vehicles (EVs) are rapidly growing in popularity and acceptance as a transportation solution. However, more widespread adoption of EVs remains impeded by various challenges, often centered around the limitations of battery technology and the consequent range anxiety that may be experienced by drivers. Conventionally, EVs rely on large onboard batteries, which not only contribute to increased vehicle weight but also have restricted energy capacities. This limitation necessitates frequent recharging stops, particularly problematic for long-distance travel and heavy-duty vehicular use. Furthermore, the existing charging infrastructure, primarily consisting of stationary charging stations, often presents issues such as long charging times and insufficient coverage, especially on highways and in remote areas. These factors collectively contribute to range anxiety among potential EV users and may deter wider acceptance of EV technology.

Moreover, the reliance on stationary charging stations poses logistical and economic challenges, both in terms of infrastructure development and energy distribution. The need to build a vast network of charging stations, capable of catering to a growing number of EVs, demands significant investment and time. Additionally, the current charging model does not optimally align with the dynamic nature of transportation, where vehicles are constantly in motion and require a more flexible and continuous energy supply.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary has the sole purpose to present certain concepts relating to one or more aspects relating to the mechanisms disclosed herein in a simplified form to precede the detailed description presented below.

Disclosed are systems, methods, apparatuses, and computer-readable media for performing wireless communication. According to at least one illustrative example, a method is provided, comprising: detecting a vehicle traveling on a roadway, wherein the roadway is associated with a plurality of power distribution units for providing electrical power to authenticated vehicles; authenticating the vehicle to receive electrical power from one or more power distribution units of the plurality of power distribution units, wherein authentication is based on identifying information associated with the vehicle; based on successful authentication of the vehicle, energizing a selected one or more power distribution units of the plurality of power distribution units, wherein the selected one or more power distribution units are selected from the plurality of power distribution units as being nearest to the authenticated vehicle; providing electrical power from at least one of the energized power distribution units to the authenticated vehicle while the authenticated vehicle travels along the roadway; and de-energizing the selected one or more power distribution units based on detecting that a load associated with the authenticated vehicle is no longer present.

In another illustrative example, an apparatus is provided. The apparatus includes at least one memory and at least one processor coupled to the at least one memory and configured to: detect a vehicle traveling on a roadway, wherein the roadway is associated with a plurality of power distribution units for providing electrical power to authenticated vehicles; authenticate the vehicle to receive electrical power from one or more power distribution units of the plurality of power distribution units, wherein authentication is based on identifying information associated with the vehicle; based on successful authentication of the vehicle, energize a selected one or more power distribution units of the plurality of power distribution units, wherein the selected one or more power distribution units are selected from the plurality of power distribution units as being nearest to the authenticated vehicle; provide electrical power from at least one of the energized power distribution units to the authenticated vehicle while the authenticated vehicle travels along the roadway; and de-energize the selected one or more power distribution units based on detecting that a load associated with the authenticated vehicle is no longer present.

In another illustrative example, a non-transitory computer-readable storage medium comprising instructions stored thereon which, when executed by at least one processor, causes the at least one processor to: detect a vehicle traveling on a roadway, wherein the roadway is associated with a plurality of power distribution units for providing electrical power to authenticated vehicles; authenticate the vehicle to receive electrical power from one or more power distribution units of the plurality of power distribution units, wherein authentication is based on identifying information associated with the vehicle; based on successful authentication of the vehicle, energize a selected one or more power distribution units of the plurality of power distribution units, wherein the selected one or more power distribution units are selected from the plurality of power distribution units as being nearest to the authenticated vehicle; provide electrical power from at least one of the energized power distribution units to the authenticated vehicle while the authenticated vehicle travels along the roadway; and de-energize the selected one or more power distribution units based on detecting that a load associated with the authenticated vehicle is no longer present.

In another illustrative example, an apparatus is provided for wireless communication. The apparatus includes: means for detecting a vehicle traveling on a roadway, wherein the roadway is associated with a plurality of power distribution units for providing electrical power to authenticated vehicles; means for authenticating the vehicle to receive electrical power from one or more power distribution units of the plurality of power distribution units, wherein authentication is based on identifying information associated with the vehicle; means for based on successful authentication of the vehicle, energizing a selected one or more power distribution units of the plurality of power distribution units, wherein the selected one or more power distribution units are selected from the plurality of power distribution units as being nearest to the authenticated vehicle; means for providing electrical power from at least one of the energized power distribution units to the authenticated vehicle while the authenticated vehicle travels along the roadway; and means for de-energizing the selected one or more power distribution units based on detecting that a load associated with the authenticated vehicle is no longer present.

Aspects generally include a method, apparatus, system, computer program product, non-transitory computer-readable medium, user equipment, base station, wireless communication device, and/or processing system as substantially described herein with reference to and as illustrated by the drawings and specification. The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims. Other objects and advantages associated with the aspects disclosed herein will be apparent to those skilled in the art based on the accompanying drawings and detailed description. This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and embodiments, will become more apparent upon referring to the following specification, claims, and accompanying drawings.

### BRIEF DESCRIPTION OF THE DRAWINGS

The accompanying drawings are presented to aid in the description of various aspects of the disclosure and are provided solely for illustration of the aspects and not limitation thereof. So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a computing system of a vehicle, in accordance with some examples;

FIG. 2 is a diagram illustrating an example contact-based power delivery system for vehicles traveling on a roadway, in accordance with some examples;

FIG. 3 is a diagram illustrating an example system for providing power delivery and management thereof to vehicles traveling on a roadway, in accordance with some examples;

FIG. 4 is a diagram illustrating an example wireless power delivery system for vehicles traveling on a roadway, in accordance with some examples; and

FIG. 5 is a block diagram illustrating an example of a computing system, in accordance with some examples.

### DETAILED DESCRIPTION

Various embodiments of the disclosure are discussed in detail below. While specific implementations are discussed, it should be understood that this is done for illustration purposes only. A person skilled in the relevant art will recognize that other components and configurations may be used without departing from the spirit and scope of the disclosure. Additional features and advantages of the disclosure will be set forth in the description which follows, and in part will be obvious from the description, or can be learned by practice of the herein disclosed principles. It will be appreciated that for simplicity and clarity of illustration, where appropriate, reference numerals have been repeated among the different figures to indicate corresponding or analogous elements. The description is not to be considered as limiting the scope of the embodiments described herein.

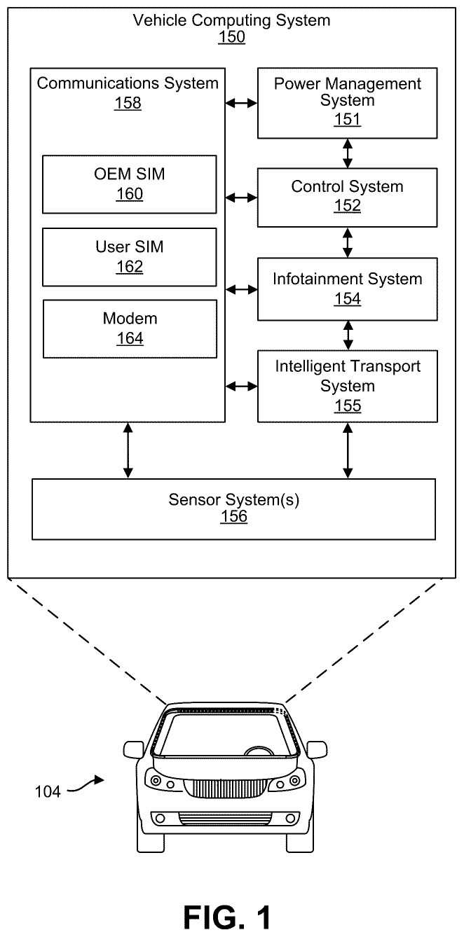

FIG. 1 is a block diagram illustrating an example a vehicle computing system 150 of a vehicle 104. The vehicle 104 is an example of a UE that can communicate with a network (e.g., an eNB, a gNB, a positioning beacon, a location measurement unit, and/or other network entity) over a Uu interface and with other UEs using V2X communications over a PC5 interface (or other device to device direct interface, such as a DSRC interface), etc. As shown, the vehicle computing system 150 can include at least a power management system 151, a control system 152, an infotainment system 154, an intelligent transport system (ITS) 155, one or more sensor systems 156, and a communications system 158. In some cases, the vehicle computing system 150 can include or can be implemented using any type of processing device or system, such as one or more central processing units (CPUs), digital signal processors (DSPs), application specific integrated circuits (ASICs), field programmable gate arrays (FPGAs), application processors (APs), graphics processing units (GPUs), vision processing units (VPUs), Neural Network Signal Processors (NSPs), microcontrollers, dedicated hardware, any combination thereof, and/or other processing device or system.

The control system 152 can be configured to control one or more operations of the vehicle 104, the power management system 151, the computing system 150, the infotainment system 154, the ITS 155, and/or one or more other systems of the vehicle 104 (e.g., a braking system, a steering system, a safety system other than the ITS 155, a cabin system, and/or other system). In some examples, the control system 152 can include one or more electronic control units (ECUs). An ECU can control one or more of the electrical systems or subsystems in a vehicle. Examples of specific ECUs that can be included as part of the control system 152 include an engine control module (ECM), a powertrain control module (PCM), a transmission control module (TCM), a brake control module (BCM), a central control module (CCM), a central timing module (CTM), among others. In some cases, the control system 152 can receive sensor signals from the one or more sensor systems 156 and can communicate with other systems of the vehicle computing system 150 to operate the vehicle 104.

In one illustrative example, the control system 152 can include or otherwise integrate/communicate with an ADAS system associated with the vehicle 104.

The vehicle computing system 150 also includes a power management system 151. In some implementations, the power management system 151 can include a power management integrated circuit (PMIC), a standby battery, and/or other components. In some cases, other systems of the vehicle computing system 150 can include one or more PMICs, batteries, and/or other components. The power management system 151 can perform power management functions for the vehicle 104, such as managing a power supply for the computing system 150 and/or other parts of the vehicle. For example, the power management system 151 can provide a stable power supply in view of power fluctuations, such as based on starting an engine of the vehicle. In another example, the power management system 151 can perform thermal monitoring operations, such as by checking ambient and/or transistor junction temperatures. In another example, the power management system 151 can perform certain functions based on detecting a certain temperature level, such as causing a cooling system (e.g., one or more fans, an air conditioning system, etc.) to cool certain components of the vehicle computing system 150 (e.g., the control system 152, such as one or more ECUs), shutting down certain functionalities of the vehicle computing system 150 (e.g., limiting the infotainment system 154, such as by shutting off one or more displays, disconnecting from a wireless network, etc.), among other functions.

The vehicle computing system 150 further includes a communications system 158. The communications system 158 can include both software and hardware components for transmitting signals to and receiving signals from a network (e.g., a gNB or other network entity over a Uu interface) and/or from other UEs (e.g., to another vehicle or UE over a PC5 interface, WiFi interface (e.g., DSRC), Bluetooth™ interface, and/or other wireless and/or wired interface). For example, the communications system 158 is configured to transmit and receive information wirelessly over any suitable wireless network (e.g., a 3G network, 1G network, 3G network, WiFi network, Bluetooth™ network, and/or other network). The communications system 158 includes various components or devices used to perform the wireless communication functionalities, including an original equipment manufacturer (OEM) subscriber identity module (referred to as a SIM or SIM card) 160, a user SIM 162, and a modem 164. While the vehicle computing system 150 is shown as having two SIMs and one modem, the computing system 150 can have any number of SIMs (e.g., one SIM or more than two SIMs) and any number of modems (e.g., one modem, two modems, or more than two modems) in some implementations.

A SIM is a device (e.g., an integrated circuit) that can securely store an international mobile subscriber identity (IMSI) number and a related key (e.g., an encryption-decryption key) of a particular subscriber or user. The IMSI and key can be used to identify and authenticate the subscriber on a particular UE. The OEM SIM 160 can be used by the communications system 158 for establishing a wireless connection for vehicle-based operations, such as for conducting emergency-calling (eCall) functions, communicating with a communications system of the vehicle manufacturer (e.g., for software updates, etc.), among other operations. The OEM SIM 160 can be important for the OEM SIM to support critical services, such as eCall for making emergency calls in the event of a car accident or other emergency. For instance, eCall can include a service that automatically dials an emergency number (e.g., “9-1-1” in the United States, “1-1-2” in Europe, etc.) in the event of a vehicle accident and communicates a location of the vehicle to the emergency services, such as a police department, fire department, etc.

The user SIM 162 can be used by the communications system 158 for performing wireless network access functions in order to support a user data connection (e.g., for conducting phone calls, messaging, Infotainment related services, among others). In some cases, a user device of a user can connect with the vehicle computing system 150 over an interface (e.g., over PC5, Bluetooth™, WiFi™ (e.g., DSRC), a universal serial bus (USB) port, and/or other wireless or wired interface). Once connected, the user device can transfer wireless network access functionality from the user device to communications system 158 the vehicle, in which case the user device can cease performance of the wireless network access functionality (e.g., during the period in which the communications system 158 is performing the wireless access functionality). The communications system 158 can begin interacting with a base station to perform one or more wireless communication operations, such as facilitating a phone call, transmitting and/or receiving data (e.g., messaging, video, audio, etc.), among other operations. In such cases, other components of the vehicle computing system 150 can be used to output data received by the communications system 158. For example, the infotainment system 154 (described below) can display video received by the communications system 158 on one or more displays and/or can output audio received by the communications system 158 using one or more speakers.

A modem is a device that modulates one or more carrier wave signals to encode digital information for transmission, and demodulates signals to decode the transmitted information. The modem 164 (and/or one or more other modems of the communications system 158) can be used for communication of data for the OEM SIM 160 and/or the user SIM 162. In some examples, the modem 164 can include a 1G (or LTE) modem and another modem (not shown) of the communications system 158 can include a 3G (or NR) modem. In some examples, the communications system 158 can include one or more Bluetooth™ modems (e.g., for Bluetooth™ Low Energy (BLE) or other type of Bluetooth communications), one or more WiFi™ modems (e.g., for DSRC communications and/or other WiFi communications), wideband modems (e.g., an ultra-wideband (UWB) modem), any combination thereof, and/or other types of modems.

In some cases, the modem 164 (and/or one or more other modems of the communications system 158) can be used for performing V2X communications (e.g., with other vehicles for V2V communications, with other devices for D2D communications, with infrastructure systems for V2I communications, with pedestrian UEs for V2P communications, etc.). In some examples, the communications system 158 can include a V2X modem used for performing V2X communications (e.g., sidelink communications over a PC5 interface or DSRC interface), in which case the V2X modem can be separate from one or more modems used for wireless network access functions (e.g., for network communications over a network/Uu interface and/or sidelink communications other than V2X communications).

In some examples, the communications system 158 can be or can include a telematics control unit (TCU). In some implementations, the TCU can include a network access device (NAD) (also referred to in some cases as a network control unit or NCU). The NAD can include the modem 164, any other modem not shown in FIG. 1, the OEM SIM 160, the user SIM 162, and/or other components used for wireless communications. In some examples, the communications system 158 can include a Global Navigation Satellite System (GNSS). In some cases, the GNSS can be part of the one or more sensor systems 156, as described below. The GNSS can provide the ability for the vehicle computing system 150 to perform one or more location services, navigation services, and/or other services that can utilize GNSS functionality.

In some cases, the communications system 158 can further include one or more wireless interfaces (e.g., including one or more transceivers and one or more baseband processors for each wireless interface) for transmitting and receiving wireless communications, one or more wired interfaces (e.g., a serial interface such as a universal serial bus (USB) input, a lightening connector, and/or other wired interface) for performing communications over one or more hardwired connections, and/or other components that can allow the vehicle 104 to communicate with a network and/or other UEs.

The vehicle computing system 150 can also include an infotainment system 154 that can control content and one or more output devices of the vehicle 104 that can be used to output the content. The infotainment system 154 can also be referred to as an in-vehicle infotainment (IVI) system or an In-car entertainment (ICE) system. The content can include navigation content, media content (e.g., video content, music or other audio content, and/or other media content), among other content. The one or more output devices can include one or more graphical user interfaces, one or more displays, one or more speakers, one or more extended reality devices (e.g., a VR, AR, and/or MR headset), one or more haptic feedback devices (e.g., one or more devices configured to vibrate a seat, steering wheel, and/or other part of the vehicle 104), and/or other output device.

In some examples, the computing system 150 can include the intelligent transport system (ITS) 155. In some examples, the ITS 155 can be used for implementing V2X communications. For example, an ITS stack of the ITS 155 can generate V2X messages based on information from an application layer of the ITS. In some cases, the application layer can determine whether certain conditions have been met for generating messages for use by the ITS 155 and/or for generating messages that are to be sent to other vehicles (for V2V communications), to pedestrian UEs (for V2P communications), and/or to infrastructure systems (for V2I communications). In some cases, the communications system 158 and/or the ITS 155 can obtain car access network (CAN) information (e.g., from other components of the vehicle via a CAN bus). In some examples, the communications system 158 (e.g., a TCU NAD) can obtain the CAN information via the CAN bus and can send the CAN information to a PHY/MAC layer of the ITS 155. The ITS 155 can provide the CAN information to the ITS stack of the ITS 155. The CAN information can include vehicle related information, such as a heading of the vehicle, speed of the vehicle, breaking information, among other information. The CAN information can be continuously or periodically (e.g., every one millisecond (ms), every 10 ms, or the like) provided to the ITS 155.

The conditions used to determine whether to generate messages can be determined using the CAN information based on safety-related applications and/or other applications, including applications related to road safety, traffic efficiency, infotainment, business, and/or other applications. In one illustrative example, the ITS 155 can perform lane change assistance or negotiation. For instance, using the CAN information, the ITS 155 can determine that a driver of the vehicle 104 is attempting to change lanes from a current lane to an adjacent lane (e.g., based on a blinker being activated, based on the user veering or steering into an adjacent lane, etc.). Based on determining the vehicle 104 is attempting to change lanes, the ITS 155 can determine a lane-change condition has been met that is associated with a message to be sent to other vehicles that are nearby the vehicle in the adjacent lane. The ITS 155 can trigger the ITS stack to generate one or more messages for transmission to the other vehicles, which can be used to negotiate a lane change with the other vehicles. Other examples of applications include forward collision warning, automatic emergency breaking, lane departure warning, pedestrian avoidance or protection (e.g., when a pedestrian is detected near the vehicle 104, such as based on V2P communications with a UE of the user), traffic sign recognition, among others. The ITS 155 can use any suitable protocol to generate messages (e.g., V2X messages). Examples of protocols that can be used by the ITS 155 include one or more Society of Automotive Engineering (SAE) standards, such as SAE J2735, SAE J2945, SAE J3161, and/or other standards, which are hereby incorporated by reference in their entirety and for all purposes.

In some examples, the ITS 155 can determine certain operations (e.g., V2X-based operations) to perform based on messages received from other UEs. The operations can include safety-related and/or other operations, such as operations for road safety, traffic efficiency, infotainment, business, and/or other applications. In some examples, the operations can include causing the vehicle (e.g., the control system 152) to perform automatic functions, such as automatic breaking, automatic steering (e.g., to maintain a heading in a particular lane), automatic lane change negotiation with other vehicles, among other automatic functions. In one illustrative example, a message can be received by the communications system 158 from another vehicle (e.g., over a PC5 interface, a DSRC interface, or other device to device direct interface) indicating that the other vehicle is coming to a sudden stop. In response to receiving the message, the ITS stack can generate a message or instruction and can send the message or instruction to the control system 152, which can cause the control system 152 to automatically break the vehicle 104 so that it comes to a stop before making impact with the other vehicle. In other illustrative examples, the operations can include triggering display of a message alerting a driver that another vehicle is in the lane next to the vehicle, a message alerting the driver to stop the vehicle, a message alerting the driver that a pedestrian is in an upcoming cross-walk, a message alerting the driver that a toll booth is within a certain distance (e.g., within one mile) of the vehicle, among others.

In some examples, the ITS 155 can receive a large number of messages from the other UEs (e.g., vehicles, RSUs, etc.), in which case the ITS 155 will authenticate (e.g., decode and decrypt) each of the messages and/or determine which operations to perform. Such a large number of messages can lead to a large computational load for the vehicle computing system 150. In some cases, the large computational load can cause a temperature of the computing system 150 to increase. Rising temperatures of the components of the computing system 150 can adversely affect the ability of the computing system 150 to process the large number of incoming messages. One or more functionalities can be transitioned from the vehicle 104 to another device (e.g., a user device, a RSU, etc.) based on a temperature of the vehicle computing system 150 (or component thereof) exceeding or approaching one or more thermal levels. Transitioning the one or more functionalities can reduce the computational load on the vehicle 104, helping to reduce the temperature of the components. A thermal load balancer can be provided that enable the vehicle computing system 150 to perform thermal based load balancing to control a processing load depending on the temperature of the computing system 150 and processing capacity of the vehicle computing system 150.

The computing system 150 further includes one or more sensor systems 156 (e.g., a first sensor system through an Nth sensor system, where N is a value equal to or greater than 0). When including multiple sensor systems, the sensor system(s) 156 can include different types of sensor systems that can be arranged on or in different parts the vehicle 104. The sensor system(s) 156 can include one or more camera sensor systems, LIDAR sensor systems, radio detection and ranging (RADAR) sensor systems, Electromagnetic Detection and Ranging (EmDAR) sensor systems, Sound Navigation and Ranging (SONAR) sensor systems, Sound Detection and Ranging (SODAR) sensor systems, Global Navigation Satellite System (GNSS) receiver systems (e.g., one or more Global Positioning System (GPS) receiver systems), accelerometers, gyroscopes, inertial measurement units (IMUs), infrared sensor systems, laser rangefinder systems, ultrasonic sensor systems, infrasonic sensor systems, microphones, any combination thereof, and/or other sensor systems. It should be understood that any number of sensors or sensor systems can be included as part of the computing system 150 of the vehicle 104.

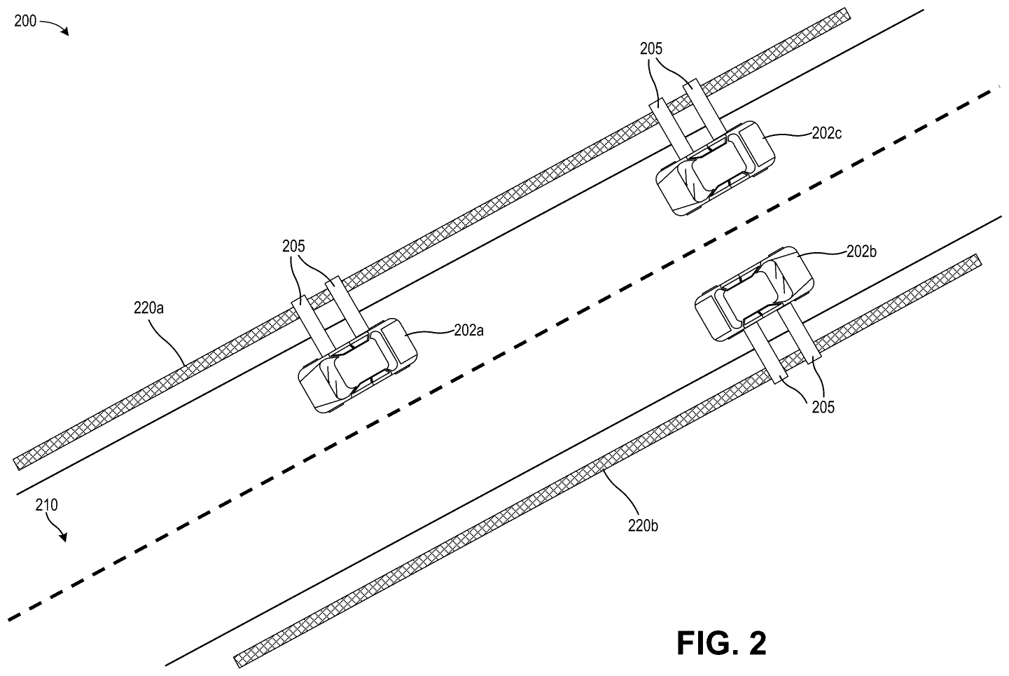

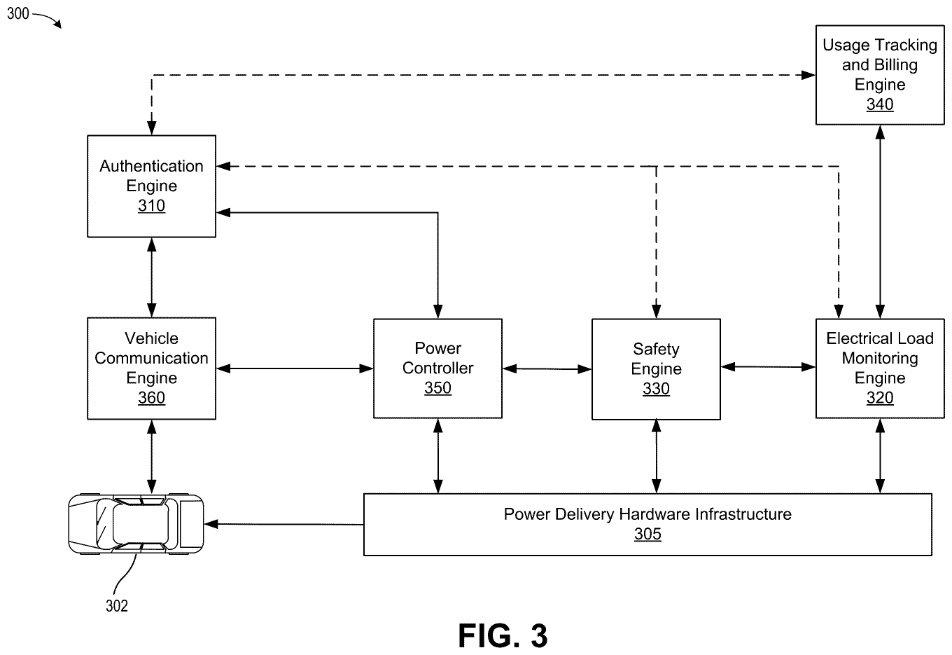

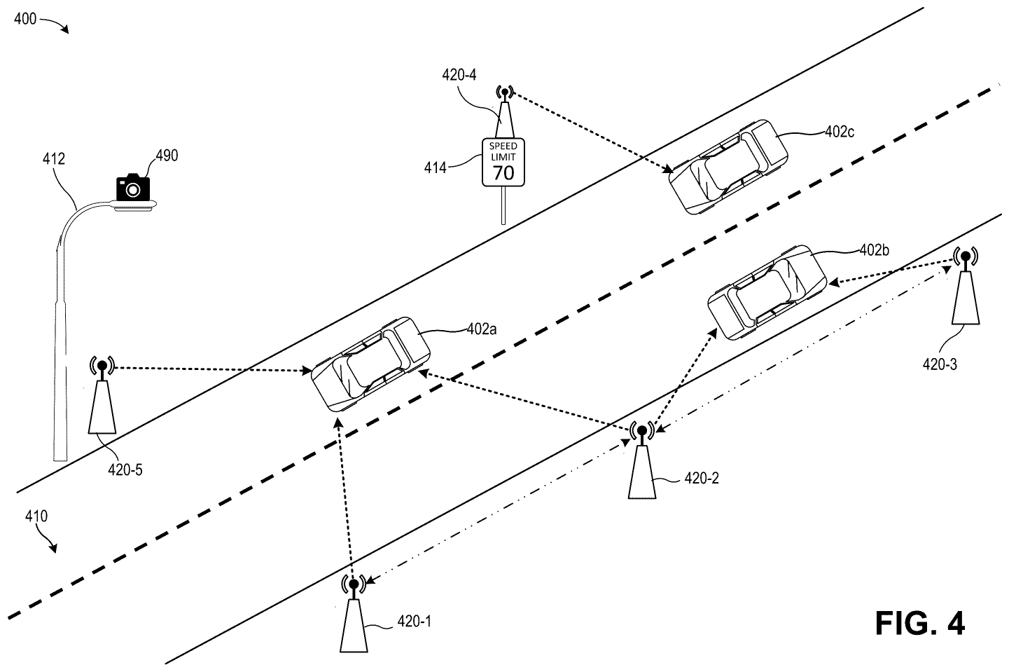

Aspects of the present disclosure are generally related to using electricity alongside and/or integrated with roadway surfaces (e.g., roads, highways, and various other surfaces suitable for or configured for vehicle travel thereupon, etc.) to power vehicles traveling on the road. For example, systems and techniques are described herein that can be used to provide electrical power to vehicles traveling (e.g., whether in motion or stationary) on a road. In some embodiments, the system can include an authentication engine configured to authenticate a vehicle attempting to connect to or otherwise draw power from the presently disclosed system, wherein the authentication engine is used to permit authorized vehicles to receive electrical power and/or to prevent unauthorized vehicles from receiving electrical power. In some aspects, the authentication engine and/or a safety engine can be configured to monitor electrical load information for one or more conductors included in the system, and to control energization of the conductors to prevent animals and children from electrocuting themselves (e.g., based on the load monitoring, etc.). In some aspects, the authentication engine can additionally be used to confirm that a connecting vehicle is properly configured to receive power. In some examples, the system can be configured to measure, determine, and/or otherwise analyze one or more electrical properties of a recipient as part of an initialization process and/or an energization process for delivering electrical power. The measurement and analysis of the various electrical properties can be implemented in addition to or instead of checking credentials using the authentication engine. In some examples, the roadway power delivery system described herein can utilize contact-based power delivery to provide electrical power to vehicles, as will be described in greater depth below with respect to the example of FIG. 2. In some examples, the roadway power delivery system described herein can utilize wireless power delivery to provide electrical power to vehicles on a roadway surface, as will be described in greater depth below with respect to FIG. 4. An example implementation of a roadway power delivery system is described with respect to the system diagram of FIG. 3.

As noted above, FIG. 2 is a diagram illustrating an example contact-based power delivery system 200 for vehicles traveling on a roadway surface 210, in accordance with some examples. In some embodiments, the contact-based power delivery can be implemented using one or more rails disposed on, near, alongside, on top of, or within (e.g., integrated into or otherwise embedded in) the road 210. For instance, in the example of FIG. 2, the road 210 is shown as a two-lane road with each respective lane providing traveling in an opposite direction from the remaining lane. In this example, a first rail 220a is provided alongside the upper travel lane of road 210 (e.g., the upper lane associated with a direction of travel from right to left) and a second rail 220b is provided alongside the lower travel lane of road 210 (e.g., the lower lane associated with a direction of travel from left to right). It is noted that the example of FIG. 2 schematically depicts the first rail 220a and the second rail 220b as single entities for purposes of clarity of illustration. In various embodiments and implementations, the first rail 220a and the second rail 220b may be provided as two-element or three-element conductive rail members. For instance, a two element rail can include a “hot” conductive rail member and a neutral conductive rail member. In another example, a three element rail can include a “hot” conductive rail member, a neutral conductive rail member, and an earth/ground conductive rail member. Accordingly, reference made herein to “a rail” or “rail” is understood to refer to various combinations of pairs and/or triples of conductive elements comprising the singular “rail.” As described in greater detail below, it is contemplated herein that the rails or other conductive elements can be provided at a height that is below the vehicles traveling on the roadway surface, and/or can be provided at a height that is above the vehicles traveling on the roadway surface.

In some embodiments, the first rail 220a can be the same as or similar to the second rail 220b. As used herein, the first rail 220a and the second rail 220b may be collectively referred to as “rails 220.” In some aspects, the rails 220 can be continuous along some (or all) of the length of the road 210. In other examples, the rails 220 can be discontinuous along the length of the road 210, with intervals of un-powered space between adjacent rails 220 along the same side of the road 210.

In one illustrative example, the rails 220 can be electrically coupled to one or more power sources. For instance, the rails 220 can be coupled to electrical mains power. In some examples, the rails 220 can be electrically powered, at least in part, by electrical power sources other than the primary electric grid associated with the geographic area or region in which the road 210 and rails 220 are located. For instance, one or more solar panel arrays, generators, etc., can be provided and electrically coupled to the rails 220 to deliver at least a portion of the total power needs for the rails 220 and/or the vehicles 202a, 202b, 202c, on a permanent, semi-permanent, or temporary basis. In some aspects, each rail unit 220 (or segment or modular/discrete portion thereof) can be connected to existing electrical power infrastructure or power distribution lines that run alongside the roadway 210. Each rail unit 220 (or segment or modular/discrete portion thereof) may additionally, or alternatively, be connected to dedicated or independent electrical power infrastructure and/or power generation capacity that is associated with one or more rail units 220 or rail segments. In addition to solar panel arrays or generators, the dedicated or independent electrical power infrastructure for energizing the rails 220 can further include batteries or other energy storage, nuclear generation systems, etc. In some embodiments, when dedicated or independent electrical power supply is utilized, each independent electrical power supply (e.g., solar, battery, nuclear, etc.) can be associated with multiple segments of rails, wherein the particular subset of rail segments associated with a given independent electrical power supply may be continuous with one another, adjacent, and/or located within relatively close proximity or the same geographic region as one another, etc.

As noted above, and shown in FIG. 2, in some embodiments, a pair of electric “rails” (e.g., the rails 220, comprising the first rail 220a and the second rail 220b) can run along the side the road 210. In some examples, a greater or lesser number of rails 220 can be used to provide electric power delivery to a greater or lesser number of lanes than shown in the example of FIG. 2. For instance, the two lane road 210 of FIG. 2 can be powered by a single rail (e.g., disposed on top of a centerline of the road 210, integrated within the surface of the road 210 on or near the centerline, etc.). In some examples, the pair of rails 220a, 220b could be used to provide electric power delivery to a four lane road, with the first rail 220a providing power to two travel lanes in a first direction and with the second rail 220b providing power to two travel lanes in a second direction. In some aspects, a rail unit 220 can be shared across two or more travel lanes of a roadway, where the lanes are associated with the same direction of travel. For instance, a rail unit 220 can be deployed between two adjacent lanes having the same travel direction, such that the first lane is to the left of the central rail unit 220 and the second lane is to the right of the central rail unit 220. In this example, the central rail unit can be shared across authorized vehicles that are traveling in either the first lane or the second lane. In some aspects, the hardware configuration of a central rail unit 220 that is shared by at least two travel lanes in the same direction can be implemented to prevent two vehicles from attempting to make contact with (e.g., via their respective conductive arms 205, etc.) the exact same portion(s) of the shared central rail 220. In some examples, each lane of a roadway can be associated with its own corresponding rail unit 220, such that a two lane road has two rails 220, a four lane road has four rails 220, a six lane road has six rails 220, etc. However, in at least some examples, the segmentation of the per-lane rail units 220 can be performed across all of the multiple lanes/rails, such that the same relative locations or areas of rail for each lane are grouped into a single segment. In other words, along the length of the roadway, separate rails 220 can be provided for each lane. Across the width of the roadway, respective portions of each one of the per-lane rails are grouped into the same segment. By grouping multiple rails/lanes into shared segments, the cost and complexity of implementing detection and authentication for each segment is shared across multiple cars in multiple lanes as well as multiple cars in the same lane.

In some aspects, vehicles (e.g., vehicles 202a, 202b, 202c, etc., which may be the same as or similar to one another) can be equipped with a robot “arm” systems to reach out and grab charge from these rails 220 as the vehicles are traveling alongside the rails 220 at speed (e.g., as the vehicles are traveling or in motion on the road 210). In one illustrative example, the vehicles can be configured to include conductive arms 205 that extend from the vehicle to make contact with at least a portion of the rails 220. For instance, the conductive arms 205 can extend from the first vehicle 202a to contact the first rail 220a and provide electric power to vehicle 202a. The conductive arms 205 equipped on vehicle 202c can likewise extend from vehicle 202c to contact the first rail 220a and provide electric power to vehicle 202c. A single rail or rail segment (e.g., first rail 220a, or segment thereof, etc.) can provide power to multiple vehicles simultaneously. In some cases, such as when only one authorized vehicle is within the vicinity of the rail or is otherwise making contact with the rail to receive or draw electrical power, a rail segment may provide power to a single vehicle. For instance, a single vehicle 202b is shown in the lower travel lane of the road 210 in the example of FIG. 2. The conductive arms 205 equipped on vehicle 202b can extend from vehicle 202b to contact the second rail 220b and provide electric power to vehicle 202b.

In some examples, each of the vehicles 202a, 202b, 202c can include conductive arms 205 that are the same (e.g., each vehicle configured for operation with the electric power delivery system 200 can use the same configuration of conductive arms 205). In some cases, different vehicles may use different types and/or configurations of conductive arms. The conductive arms can be fixed in place on the vehicles 202a, 202b, 202c or may be extendable or retractable from the vehicle to receive electric power when needed and to stow when electric power is not needed (respectively). In some cases, the conductive arms 205 can comprise a greater or lesser number of individual or discrete conductors or arm elements than the two that are shown for each vehicle in the example of FIG. 2. For instance, a vehicle may use a single conductive arm 205 to couple to a rail 220 to receive electrical power. In other examples, a vehicle may use a plurality of conductive arms or conductive elements to couple to a rail 220 to receive electrical power. In some embodiments, vehicles may utilize a brushed contact or interface with the surface of rail 220 to receive electrical power. In some aspects, some (or all) of a rail 220 may be embedded in the surface of the road 210, such that the top of the rail 220 is below the road surface, is flush with the road surface, or extends only partially out of and above the road surface, etc. In some examples, rails 220 embedded into the road 210 can be used to provide electrical power to vehicles 202 via the same or similar conductive arms 205 described above.

FIG. 3 is a diagram illustrating an example system 300 for providing power delivery and management thereof to vehicles traveling on a roadway, in accordance with some examples. For instance, the power delivery system 300 can be used to implement the contact-based roadside vehicle power of the example of FIG. 2 and/or can be used to implement the wireless roadside vehicle power of the example of FIG. 4, etc. In one illustrative example, the power delivery system 300 of FIG. 3 includes power delivery hardware infrastructure 305 that can be used to provide electrical power to one or more vehicles 302. The vehicle 302 can be the same as or similar to the vehicles 202a, 202b, 202c of FIG. 2 and/or the vehicles 402a, 402b, 402c of FIG. 4. The power delivery hardware infrastructure 305 can include some (or all) of the power delivery hardware components depicted in and/or described with respect to one or more (or both) of FIG. 2 and FIG. 4.

In some aspects, the power delivery system 300 can include an authentication engine 310 that may utilize various ways of detecting whether the connecting vehicle 302 is authorized to receive power from the power delivery hardware infrastructure 305. For instance, the authentication engine 310 can authorize a connecting vehicle 302 to receive power based on analyzing and confirming the presence of one or more configured visual markings displayed on or by the vehicle 302; based on one or more Radio Frequency Identification (RFID) tags on or associated with the vehicle 302 (e.g., interrogated and/or read by a vehicle communication engine 360 included in the system 300 and connected to and/or associated with the authentication engine 310); based on one or more RFID transmissions between the vehicle 302 and the vehicle communication engine 360; etc. In some embodiments, a connecting vehicle 302 can perform authentication (e.g., with the authentication engine 310 and/or via the vehicle communication engine 360 communicatively coupled therebetween) based on using the rails 220 and/or other power lines included in the power delivery hardware infrastructure 305 to transmit identity information uniquely corresponding to the connecting vehicle 302, as will be described in greater detail below. In some aspects, the unique identity information of a connecting vehicle 302 that is transmitted over the rails 220 or power lines can be the same as the RFID tag identifier (e.g., RFID tag identity is transmitted over the rails 220, in addition to or alternative to via RF wave after interrogation of the RFID tag). In some aspects, vehicle authentication can be implemented by the authentication engine 310 based at least in part on a public key authentication dialog between the authentication engine 310 and a connecting vehicle 302. It is noted that various other systems, techniques, process, methods, etc., can be used to perform vehicle authentication and/or can be implemented by the authentication engine 310 for purposes of performing the vehicle authentication described above and herein; the example authentication techniques described above are provided for purposes of illustration and example and are not intended to be construed as limiting. For instance, the authentication engine 310 and/or the vehicle authentication engine can additionally, or alternatively, be based on techniques that can include, but are not limited to, the use of listings of shared one-time-use passwords (e.g., shared between connecting vehicles 302 and the system 300/authentication engine 310), the use of hashes with a clock, various public key systems, etc.

In some embodiments, authentication of a connecting vehicle 302 can be performed based on detecting that the vehicle 302 has pulsed a corresponding authentication code electrically into the rail (e.g., a rail included in power delivery hardware infrastructure 305, which can be the same as or similar to one or more of the rails 220a, 220b of FIG. 2, etc.) to receive power. For instance, an electrical load monitoring engine 320 may be coupled to the power delivery hardware infrastructure 305 and configured to monitor the electrical load (and/or characteristics thereof) within one or more rails or other power delivery components of the hardware infrastructure 305. The electrical load monitoring engine 320 can be communicatively coupled with the authentication engine 310, and based on the detection or readout of an expected authentication code electrically pulsed into the rail by the vehicle 302, the authentication engine 310 can approve (e.g., authenticate) the vehicle 302 to begin receiving power from the hardware infrastructure 305 and/or can configure a power controller 350 associated with the hardware infrastructure 305 to begin providing electrical power to the vehicle 302. In some embodiments, the authentication of a connecting vehicle 302 using pulsed authentication information/pulsed transmissions over the rails 220 can be based at least in part on a public key authentication dialog between the authentication engine 310 and the connecting vehicle 302, as noted previously above. In some aspects, the authentication protocol between the authentication engine 310 and the connecting vehicle 302 is pulsed such that every unit time the system 300 is configured to recheck or otherwise verify that connecting vehicles 302 are authenticated to draw electrical power and that nothing else (e.g., no humans, animals, foreign objects, or other non-vehicular contacts, etc.) is touching the rails 220. In some aspects, the system 300 (e.g., the authentication engine 310, safety engine(s) 330, electrical load monitoring engine 320, etc.) can be configured to continuously (or periodically) check the electrical load information to ensure that the right amount and/or type (e.g., expected amount and/or type) of load is currently present on the system (e.g., present on the power delivery hardware infrastructure 305, provided by the power controller 350, etc.).

In some embodiments, the rails (e.g., rails 220 of FIG. 2) can be segmented into a plurality of rail segments that correspond to an average vehicle length. For instance, the rails 220 can comprise a plurality of connected rail segments with each rail segment having a length that is approximately equal to the average length of the vehicles (e.g., average length of vehicles 202a, 202b, 202c, etc.). In some examples, each rail segment can have a length that is greater than the average length of the vehicles by a pre-determined amount. Based on segmenting the rails 220 into a plurality of respective rail segments, an authorized vehicle can be bumper to bumper with an unauthorized vehicle immediately in front of and/or in back of the authorized vehicle, while only the authorized vehicle will be within reach of power. For instance, by using a rail segment length approximately equal to the length of the authorized vehicle (or an average vehicle length within which the length of the authorized vehicle falls), the power controller 350 can selectively energize and de-energize the respective rail segment that is closest to the authorized vehicle at a given point in time, while maintaining a de-energized state of a first respective rail segment that is closest to the unauthorized vehicle immediately in front and also maintaining a de-energized state of a second respective rail segment that is closest to the unauthorized vehicle immediately in back.

In some embodiments, the power delivery and management system 300 can include systems to record and report unauthorized vehicles attempting to use power from the power delivery hardware infrastructure 305 (e.g., unauthorized vehicles attempting to draw power from the rails 220, etc.). In one illustrative example, the authentication engine 310 can be configured to record and report unauthorized vehicles attempting to use or otherwise draw power from the power delivery hardware infrastructure 305.

In some aspects, the authentication engine 310 can be designed to provide strong safety characteristics by ensuring that an individual person or animal touching a rail 220 or other energized and non-insulated component of the power delivery hardware infrastructure 305 cannot get electrocuted. The system 300 can additionally be configured to prevent fires by detecting if the electric load does not have well-functioning vehicle characteristics (e.g., the proper resistance and regular sending of the authentication code) and turns off immediately in such a case. For example, the power controller 350 can be commanded to cut power to or otherwise de-energize any rails 220 (or rail segments thereof, etc.) for which a non-vehicular electric load is detected and/or for which a vehicular electric load is detected but with non-well-functioning vehicle characteristics. In some embodiments, the system 300 and the power controller 350 can be configured to ramp up power delivery to a connected vehicle 302 after successful authentication of the connecting vehicle 302 by the authentication engine 310. For instance, in some embodiments, the authentication process performed by the authentication engine 310 can include determining or negotiating a maximum authorized power delivery for the connected vehicle 302. The maximum authorized power delivery can be indicative of a maximum rate of delivery (e.g., in units of Watts, etc.), a maximum quantity for delivery (e.g., in units of kilowatt-hours, etc.), or both. For instance, authenticating a connecting vehicle 302 may include determining that the authenticated vehicle is authorized to receive a maximum of 400 kWh at a power/rate of 1 kW, etc. In one illustrative example, the power controller 350 can be configured (in combination with the electrical load monitoring engine 320 and/or safety engine 330) to measure changes in electrical properties on the power delivery hardware infrastructure 305 and/or connection with the connected vehicle 302 as power delivery begins. For a connecting vehicle 302 with a maximum authorized power/rate of 1 kW, the power controller 350 can ramp the delivery by gradually increasing the energization of the rail 220 segments in contact with the vehicle 302 arms 205 from 0-1 kW. The power delivery ramping performed by power controller 350 can be continuous or stepped. In some embodiments, during the power delivery ramping process, the safety engine 330 and electrical load monitoring engine 320 can continuously monitor the load on the power delivery hardware infrastructure 305 and rails 220, to ensure that as the rails become increasingly energized, there remains nothing drawing electricity from the line that shouldn't be (e.g., no safety issues of non-vehicular contacts or non-well-functioning vehicular contacts, and no contacts from non-authorized vehicles).

In one illustrative example, the system 300 includes one or more safety engines 330 that are communicatively coupled with the power delivery hardware infrastructure 305, the electrical load monitoring engine 320, and the power controller 350. In some aspects, the safety engine 330 can additionally communicate with the authentication engine 310. The safety engine 330 can be configured to detect contact with the rail (e.g., hardware 305) by a human, animal, biological entity, and/or various other objects that are not the conductor arms 205 mounted to the vehicles shown in FIG. 2. The rail contact detection can be based on information from the electrical load monitoring engine 320 and/or power controller 350. Based on detecting contact with a rail that is not from a conductor arm 205, the safety engine 330 can generate one or more alerts, faults, or notifications, and can additionally trigger the power controller 350 to de-energize the rail (or portion/segment of the rail) where the detected contact is located.

In some embodiments, human interaction with a rail 220 or other non-insulated and energized component of the hardware infrastructure 305 can be based on touch sensing techniques, which can be used to detect or sense when a human is physically interacting with the energized component. For example, touch sensors can be installed in or near the rail 220 (or other energized hardware component of the power delivery infrastructure 305) to detect human touch. Touch sensing can be used to detect physical interaction, rather than measuring power draw. In some embodiments, the system 300 can include one or more motion sensors associated with the power delivery hardware infrastructure 305 and used to trigger an alert or detection at the safety engine 320 when the presence of a person is detected near a rail 220 or other energized component. The safety mechanisms associated with authentication engine 310, power controller 350, and/or safety engine(s) 330 can be implemented to monitor for non-vehicular loading (e.g., touches or contact from a human, animal, foreign object, fire threat, etc.) in a continuous and/or ongoing fashion. For instance, ongoing monitoring can be continuously performed in real-time to ensure that non-vehicular contact is not made with any energized rails or other conductive components of the power delivery hardware infrastructure 305.

In some cases, safety engine 330 can combine touch sensing and motion detection. In one illustrative example, the system 300 can perform analysis of power draw patterns to distinguish between the consistent power draw of a vehicle and the variable or less predictable power draw that may occur with a human interaction or touch to the rail 220. For instance, vehicles may be expected to have specific or relatively predictable power draw patterns, while human touches can correspond to more variable power draw patterns. In some cases, the system 300 can include and/or utilize one or more additional sensors to perform the touch detection and/or fire prevention and mitigation. For instance, power monitoring as described above (e.g., implemented using electrical load monitoring engine 320 and/or power controller 350) can be combined with various different sensor types such as motion sensors, touch sensors, etc., to better differentiate between a vehicle drawing power from the rail 220 (via conductive arms 205) and a human interacting with the energized rail 220.

In some cases, the electrical load monitoring engine 320 can implement monitoring of power consumption in real-time with individual vehicle level granularity and/or individual rail segment level granularity. For instance, per-vehicle usage tracking or power consumption information can be accurately determined based on previously authenticating a unique identity for each connecting vehicle 302 (e.g., using the authentication engine 310, as described previously above). In some aspects, the electrical load monitoring engine 320 can additionally provide detailed information about energy usage over a configurable time interval, on the granularity level of a single vehicle, multiple vehicles/a group of vehicles, a single rail segment, multiple rail segments, etc. In one illustrative example, the electrical load monitoring engine 320 can provide the monitoring information to a usage tracking and billing engine 340 to charge a user account associated with each respective vehicle that is identified or detected using a quantified amount of electrical power from the power delivery hardware infrastructure 305. In some embodiments, the system 300 can use the electrical load monitoring engine 320 to determine the actual power delivered to each vehicle of a plurality of vehicles (with the authentication engine 310 used to authenticate unique identity information of each connecting vehicle 302 that can be used to correlate power consumption with a corresponding vehicle/owner/user account for each unique connecting vehicle 302 identity). The actual power delivered to each connecting vehicle 302 can be tracked, measured, or otherwise determined at least in part by the usage tracking and billing engine 340. In some aspects, the usage tracking and billing engine 340 can bill at a pre-determined or set rate per unit consumption of delivered electric power. In some examples, the usage tracking and billing engine 340 can be configured to implement various forms of dynamic pricing and billing. For instance, this can include, but is not limited to, approaches such as charging based on the overall load on the system 300 (e.g., higher rate per unit of electricity when system load is higher; lower rate per unit of electricity when system load is lower); charging based on the time of day (e.g., higher per unit pricing during higher periods of demand, such as morning or evening rush hours; higher or lower pricing on weekdays vs. weekends; etc.); charging based on information of the vehicle or vehicle type; charging based on information of the vehicle owner or driver; etc.

In some examples, the electrical load monitoring engine 320 can implement circuit level monitoring, for example monitoring power usage at a circuit or breaker level granularity to identify which circuits are drawing power. In some cases, different rail segments (or different subsets of the plurality of rail segments comprising a rail 220) can be on different power distribution circuits. The electrical load monitoring engine 320 can be used to identify which circuit is drawing power, and associated characteristics and details of the circuit-level power draw. In some embodiments, a type of vehicle can be identified based on respective or corresponding power usage patterns detected in the monitoring information obtained using the electrical load monitoring engine 320.

In some embodiments, the power delivery hardware infrastructure 305 can include a third rail to ground in the case of power surges. For instance, the first rail 220a and/or the second rail 220b can be associated with a third rail to ground. In some cases, the first rail 220a and the second rail 220b can share a common (e.g., same) third rail to ground. In some embodiments, the system 300 can be configured to monitor and/or analyze patterns of electric power draw for individual ones of the connected vehicles 302 (e.g., determined by the electrical load monitoring engine 320 and/or usage tracking and billing engine 340) to detect or otherwise determine information such as which vehicles 302 may be in need of maintenance imminently, which vehicles are experiencing power draw fluctuations above or below an average for that vehicle or configured thresholds, etc. In some examples, maintenance information, health information, or other status information determined for a connected vehicle 302 as described above can be automatically reported by the system 300 to the vehicle owners and/or road authorities.

In some embodiments, the rails 220 and/or other power delivery hardware infrastructure 305 can be configured to deliver electric power using alternating current (AC), using direct current (DC), or using both/various combinations of the two. For instance, AC may provide more efficient transmission and delivery over distance before reaching the rails 220/power hardware 305, but would typically require conversion to DC before being usable by the vehicle 302 to provide motive force. DC electrical power provided from the hardware infrastructure 305 could be used immediately, or more directly, by the vehicle 302 e.g., without requiring the vehicle 302 to first perform rectification or other AC-to-DC conversion. In some embodiments, the vehicles 302 can be configured to signal to or otherwise negotiate with the system 300 what form of current is most efficient for the particular vehicle's motor system, and the system 300 delivers the requested current pulsed or alternated in the corresponding pattern to the vehicle 302. For instance, the vehicle can communicate its power requirements or request to the vehicle communication engine 360, which may subsequently configure the power controller 350 to control the power delivery hardware infrastructure 305 to deliver the requested type of current to the vehicle 302 via the power delivery hardware infrastructure 305. If multiple vehicles are trying to use power at the same time with incompatible requests, the system 300 can be configured to select one of the protocols requested by at least one of the vehicles, and notify the vehicles of the selected protocol. For instance, the selected protocol will be compatible with a first portion of the requesting vehicles and will be incompatible with a second or remaining portion of the requesting vehicles. The system 300 can be configured to message the incompatible vehicles to disconnect (e.g., prior to the energizing of the rail using the incompatible protocol for that vehicle). The system 300 can subsequently confirm that each incompatible vehicle for which the disconnect message was sent has disconnected before delivering power (e.g., before energizing the rail using the selected protocol for power delivery). For example, the system 300 can be configured to confirm that a vehicle has disconnected either by noticing how power is traveling on the line (e.g., analyzing the characteristics of the electrical load information from the electrical load monitoring engine 320) and/or by receiving an explicit communication from the vehicle using radio or electrical messaging systems (which in some embodiments may also be used to communicate the identity information as described previously above).

In some embodiments, the power delivery hardware infrastructure 305 can be provided in or on the road itself in particular lanes, e.g., as described above with respect to the example of the rails 220 of FIG. 2. This allows the system 300 to provide power to lanes that are not on the side of the road (e.g., middle or interior lanes of a multi-lane road).

In some embodiments, the system can be running above one or more lanes (or each lane) of the road, for instance utilizing overhead wires, rails, etc. In some aspects, overhead power delivery can be combined with roadside power delivery (e.g., rails 220, etc.) along the length of a given road. For instance, a first subset of the road length can be equipped with ground-based or road surface-integrated power delivery rails the same as or similar to the rails 220 of FIG. 2, while a second or remaining subset of the road length can be equipped with aerial or overhead power delivery wires, etc.

In some embodiments, the system 300 can be configured to reach out and touch the vehicles 302 rather than have the vehicles 302 reach out to contact the rails 220 or other power delivery hardware infrastructure 305 component. In this example, authorized vehicles can be configured to include one or more rails running along one or more of the vehicle's sides(s), top(s), and/or bottom(s), and the roadside system 300 can include robotic arms as a component of the power delivery hardware infrastructure 305. For instance, the robotic arms included in the power delivery hardware infrastructure 305 can be controlled to extend or otherwise reach out and establish an electrical connection with (e.g., make contact with) the conductive rails or strips on the vehicles 302, as the vehicles 302 go by each of the robotic arms. In some aspects, the power delivery hardware infrastructure 305 can include the robotic arms or other actuatable components that can be brought into contact with conductive rails on the authorized vehicles 302 in scenarios where the vehicles 302 are prohibited from including or otherwise lack the conductive arms 205 that stick out on the sides of the vehicles 302. In some embodiments, the system 300 can be configured to move the conductive arms over a pre-determined or maximum distance or span to the corresponding conductive rails or strips provided on the authorized vehicles 302. For instance, the system 300 can be configured to control the movable conductive arms over a configured distance, which may be a static length or a dynamic length (e.g., not necessarily a fixed length or distance to the vehicle 302). In example, the system 300 can include and utilize robot arms reach out a configurable distance for each vehicle 302. Accordingly, overhead systems can charge cars as well as trucks and buses even though they are of different heights. The distance can be configured based on a rail type and in real-time.

In some embodiments, the contact power delivery system (e.g., included in the power delivery hardware infrastructure 305) for connecting the rails 220/conductors of the power delivery hardware infrastructure 305 to the vehicle 302 may include wheels, gears, or brushes, etc. In some embodiments, the vehicles 302 can be continuously connected to power via contact with the conductors of the power delivery hardware infrastructure 305 or rails 220, and may be equipped without onboard power storage (e.g., without batteries, etc.). In some embodiments, the vehicle 302 has some onboard power storage, for instance because the vehicle 302 can be a hybrid and carries fuel or because the vehicle 302 is also carrying batteries, etc.

In some embodiments, such as in examples where the rails 220 or power delivery hardware 305 is segmented into discontinuous strips, portions, segments, etc., along the length of the road 210, for some parts of some routes, the vehicle 302 can utilize its momentum to carry the vehicle 302 from one power source to the next (e.g., vehicle 302 can rely on its momentum to carry it along the non-energized sections of the road between the adjacent but discontinuous segments of rails 220 or other power delivery hardware 305). In some embodiments, the vehicle 302 can use onboard stored power to get from one power source to the next. In some embodiments, stored power at vehicle 302 (e.g., battery power, hybrid power, etc.) can be used for any one of moving the vehicle 302 forward, powering batteries on the vehicle 302, or using power for other purposes for systems on the vehicle 302. In some embodiments, the vehicle 302 may be propelled or otherwise travel based on rolling motion (e.g., tires or wheels), as well as various other types of motion, which can include, but are not limited to, leaping, flying, gliding, etc., as well as rolling between segments. For instance, particularly in examples where power is delivered on lines above the road, vehicles may perform non-rolling movements between segments, etc. For instance, in such examples, a flying vehicle may be stationary on its segment while charging or otherwise readying to jump to the next segment.

In some embodiments, the system 300 can track how much power is delivered to the vehicle 302 and can bill the responsible party for the tracked power consumption. For instance, the system 300 can utilize the usage tracking and billing engine 340, which can be coupled to the electrical load monitoring engine 320 to track and/or otherwise monitor and quantify the delivery of electrical power to respective vehicles of a plurality of vehicles that use the system 300 over a configured period of time (e.g., over the configured billing interval or other time interval, etc.). In some embodiments, the system 300 can be configured for reporting vehicle use of power to those designated to receive it.

In some embodiments, alternative to or in addition to relying on direct electrical contact between the vehicle 302 and conductive rails 220/power delivery hardware 305, the systems and techniques described herein can provide roadside power delivery based on magnetic resonant wireless power transmission or inductive charging. In some embodiments, the wireless power transfer system(s) described herein (e.g., system 300, etc.) can be configured to cover or span sufficient distance so that there is no need for arms (e.g., conductive arms 205 mounted on the vehicles, or robotic conductive arms included in the power delivery hardware 305, etc.) to reach out at all or substantially reduces the distance the arms need to reach out. In the case of magnetic resonant wireless transmission, some embodiments can be configured to provide wireless power delivery utilizing pairs of wires on the side of the road rather than coils to transmit power wirelessly to one or more vehicles 302.

In some embodiments, awareness of the power system 300 can be directly integrated into vehicle autonomy systems (e.g., running primarily in the vehicle 302 or reliant on information provided by roadside cameras and sensors) to keep the vehicle 302 driving in a manner that maximizes charge. For instance, the vehicles 202a, 202b, 202c of FIG. 2 and/or the vehicle 302 of FIG. 3 can be the same as or similar to the vehicle 104 of FIG. 1, and can utilize a power management system 151 and/or control system 152 with awareness of the presently disclosed roadside power delivery system 300. In some cases, the vehicle autonomy systems configured to drive the vehicles 302 to maximize charge or state of charge can be included in or implemented by the intelligent transport system 155 included in the vehicle computing system 150 of FIG. 1. In some embodiments, the system 300 can be implemented to include or provide beacons that allow detectors (e.g., RF receivers, etc.) provided on or integrated with the vehicles 302 to have a very clear sense of where the beacons are located and to give the driver or autonomy system sufficient information to drive the vehicle 302 in a manner that maximizes charge.

In some aspects, surveillance systems can be used to record and track individuals engaged in interfering with behavior of the system 300, including but not limited to attempting to steal parts from the system 300 (e.g., from the power delivery hardware infrastructure 305) or to otherwise damage the system 300 and/or power delivery hardware infrastructure 305. In some cases, the surveillance system may also be used to detect whether people, animals, or debris are too close to the energized conductors (e.g., rails 220, etc.) implemented by the system 300 and included in the power delivery hardware infrastructure 305 to risk turning that segment on and preventing that segment from turning on. In some cases, the system 300 can be configured to also record and report that issue (e.g., detected by surveillance systems as a theft or vandalism event and/or detected by surveillance systems and/or safety engine 330 as a touch event, etc.) to authorities for resolution or other remediation. In some embodiments, deployment of the roadside power delivery system 300 can be associated with installing signage indicating to drivers that only properly authorized vehicles may use powered lanes of the road 210 at certain times, etc.

In another illustrative example, the systems and techniques described herein can be used to implement wireless power transfer technologies to power vehicles on or near roads or aircraft flying at low altitude above the roads. As used herein, the terms “path” or “paths” may be understood to refer to any path, road, way, highway waterway, etc. on which wireless transfer power sources are provided at regular or semi-regular intervals on light posts, signposts, regular posts, or various other objects along roads. In some examples, wireless transfer power sources can be provided at a separation distance or interval that is usually less than 100 m apart. As used herein, “vehicles” can refer ground or water-based vehicles and aircrafts on, above, or nearby such roads.

In some embodiments, the systems and techniques described herein can be used for deploying wireless power transfer sources to construct a powered path for travel of a vehicle, deploying wireless power transfer receivers on at least some vehicles using these paths, identifying vehicles that are eligible for being powered because they are permitted, have paid, and are properly configured, and organizing the system so each source delivers power to eligible vehicles when they are most proximate, so power to eligible vehicles is handed off as the eligible vehicles progress along the path. The result of this system is that the powered vehicles can use much less onboard power to progress at speed along the path. The system need not guarantee perfect handoffs. The system will calculate the extent to which momentum can deliver a vehicle past a post that is already at capacity, so the hand-offs need not be perfectly sequential.

FIG. 4 is a diagram illustrating an example wireless power delivery system 400 for vehicles traveling on a roadway, in accordance with some examples. In some embodiments, the road 410 of FIG. 4 can be the same as or similar to the road 210 of FIG. 2. The vehicles 402a, 402b, and 402c of FIG. 4 can be the same as or similar to one another, and may additionally be the same as or similar to one or more of the vehicle 104 of FIG. 1 and/or the vehicles 202a, 202b, 202c of FIG. 2. As used herein, the vehicles 402a, 402b, 402c may be collectively referred to as “vehicles 402.”

As illustrated in FIG. 4, the roadside wireless power delivery system 400 can include a plurality of wireless power transmitters 420-1, 420-2, 420-3, 420-4, 420-5, etc. (collectively referred to as “transmitters 420”), which can be the same as one another, similar to one another, and/or different from one another. In some aspects, the wireless power transmitters 420 can be deployed as standalone installations, such as the standalone/dedicated wireless power transmitters 420-1, 420-2, and 420-3 shown in FIG. 4. One or more wireless power transmitters 420 can additionally be installed upon, combined with, attached to, or otherwise associated with various existing roadside infrastructure or roadside objects. For instance, the wireless power transmitter 420-4 can be attached to, combined with, integrated with, etc., a speed limit sign 414 or other roadside signage; the wireless power transmitter 420-5 can be associated with a streetlamp 412; etc.

In some embodiments, each vehicle can include one or more power receivers for receiving wireless electrical power from one or more nearby transmitters 420. For instance, power receivers for receiving wireless electrical power from one or more of the transmitters 420 can be provided towards the top of ground or water-based vehicles (e.g., such as the vehicles 402a, 402b, 402c, etc.) and can be provided on the bottom of aircraft vehicles. In some embodiments, vehicles can include one or more systems to block transferred power from entering the vehicle or aircraft itself, for example using heat insulation, reflectors, or Faraday cage structures.

In some embodiments, a vehicle 402 can be configured to signal or otherwise communicate to the specific power transmitters 420 that the vehicle 402 is ready to receive power from the particular power transmitter 420. For instance, the vehicle 402 can communicate wirelessly with the vehicle communication engine 360 of FIG. 6 to signal or negotiate wireless power transmission from a particular power transmitter 420 that is nearby to the vehicle 402. In some aspects, the vehicle 402 can broadcast to any nearby transmitters 420 that are within range to receive the vehicle 402 broadcast. In other examples, the vehicle 402 can be pre-configured with a system map or other information indicative of the locations or relative positions of the different wireless power transmitters 420 along the road 410. In some cases, the vehicle 402 can perform real-time discovery to map wireless power transmitters 420 along the road, and can store the discovered location information of the transmitters 420 to an onboard mapping database or other memory of the vehicle 402.

Based on the signaling or other communication from the vehicle 402, the nearby wireless power transmitter 420 can use the signal (and information contained in or otherwise indicated by the signal) to aim wireless power transmission at the current or predicted location of the vehicle 402. For instance, the wireless power transmitters 420 can be configured to perform beamforming of wireless power to the current or predicted location of the vehicle 402. In some embodiments, decision making to select a particular transmitter 420 from the plurality of transmitters 420-1, . . . , 420-5 for delivering power to a particular vehicle 402 can be implemented by an operating system associated with the transmitters 420. For instance, the selection of a particular transmitter 420 to provide wireless power to a vehicle 402 can be implemented using the power delivery and management system 300 of FIG. 3, where the wireless power transmitters 420 are included in the power delivery hardware infrastructure 305 of the system 300 of FIG. 3. In some embodiments, an operating system of or for the plurality of wireless power transmitters 420 can be implemented by the power controller 350 of the system 300 of FIG. 3. In some embodiments, posts or other roadside objects/installations can be configured with multiple wireless power transfer sources on the same post so as to be able to power multiple vehicles 402, particular when multiple vehicles 402 are within range and traveling in disparate directions (e.g., travel lanes with opposite directions of travel, etc.).

A given vehicle can be within range of multiple wireless power transmitters 420, and thee system 300 can select a particular transmitter from the set of transmitters in range of the vehicle 402. For instance, the vehicle 402a is shown in FIG. 4 as being within wireless power delivery range of the transmitters 420-1, 420-2, and 420-5. In some aspects, the system 300 can select a particular one of the transmitters 420-1, 420-2, and 420-5 based on various factors such as current or future distance to the vehicle 402a, whether the vehicle is moving towards or away from the respective transmitter, the predicted efficiency of wireless power delivery/transfer from the respective transmitter to the vehicle 402a, the current utilization or remaining/available wireless power transmission capacity of the respective transmitter, etc.

In some cases, the same wireless power transmitter 420 can provide simultaneous wireless power delivery to multiple vehicles. For instance, in the example of FIG. 4, the transmitter 420-2 is shown as providing simultaneous wireless power delivery to vehicles 402a and 402b. In some examples, the same vehicle can receive wireless power from multiple transmitters 420 simultaneously. For instance, in the example of FIG. 4, the vehicle 402b is shown as receiving simultaneous wireless power delivery from transmitter 4290-2 and transmitter 420-3.

Various wireless power transfer technologies and techniques are currently under development and may be utilized in the context of the present disclosure. Many are designed for close contact with the powered device, e.g. inductive charging pads for mobile phones or inductive charging systems to be installed in paved roads. Others are designed for transfer over distances far in excess of 100 m. Such systems usually involve microwave, maser, or laser systems designed to transfer power over distances in excess of a kilometer. Delivering power over such distances is lossy and often requires large transmitters and receivers.

Advantageously, the systems and techniques described herein can be used to deploy wireless transfer of electrical power along a vehicle 402 path of travel, utilizing and optimizing microwave, maser, or laser systems for only the relatively short distances from a roadside wireless power transmitter 420 to the nearby vehicle 402. This shorter distance allows for much more efficient power transfer with smaller and less expensive transmitters 420 and on-board vehicle 402 receivers. Being closer and having multiple transmitters 420 simultaneously with a view of the vehicles 402 (e.g., within wireless power transfer range of the vehicles 402) also corresponds to the availability of multiple different angles from transmitter 420 to vehicle 402 that can be used to aim power specifically at the receiver onboard the vehicle 402. For instance, as noted above, vehicle 402a can select from the different respective angles of power transmission corresponding to power transmission from transmitter 420-5, 420-2, or 420-1. Vehicle 402b can select from the different respective angles of power transmission corresponding to power transmission from transmitter 420-2 or 420-3.

In some embodiments a magneton or a klystron can be implemented by one or more transmitters 420 and used to transfer microwave power to provide electrical energy to the vehicles 402.

In some embodiments, power to a vehicle 402 immediately turns off (e.g., transmission by the transmitter 420 immediately ceases) if the targeted vehicle 402 signals it is not receiving the power successfully or above a configured or specified quality or efficiency threshold. Cessation of wireless power delivery based on signaling from vehicle 402 can be a temporary pause, and the system 300 and wireless power transmitters 420 can be configured to attempt to establish (e.g., re-establish) a reliable link to the vehicle 402. The signaling mechanism from the vehicle 402 to the system 300 (e.g., to the vehicle communication engine 360) and/or transmitters 420 may be optical or radio based.

In some aspects, the system 300 of FIG. 3 and/or the wireless power transmitters 420 of FIG. 4 can be used to implement power beaming technology on light posts, sign posts, regular posts or assorted objects along roads. The posts are typically at intervals of less than 50 m and are capable of beaming power over short distances to electric vehicles on the roads. Providing power while traveling enables traversal of longer distances without the need for a traditional recharge. In other embodiments, this system can beam power up at drones or other aircraft flying on paths in the airspace proximity to the roads. To receive power from the posts, a vehicle on the road can be configured with a power receiver. The power receiver can be installed, for example, on the roof of the vehicle. The power receiver can be configured to match the power transmission technique, in order to properly receive the power at the vehicle. In an aircraft, the power receiver can be positioned on the aircraft's undercarriage.

In some embodiments, power can be delivered using microwave transmission by the transmitters 420 with diode receivers on the vehicles 402. For example, deploying power transmission at regular shorter intervals on roads to eliminate the need for them to carry much power storage. One advantage of the shorter range is that the sizes of transmission and receiving systems can be smaller and less expensive. In other embodiments, power can be delivered via powerful light with receivers being solar panels, e.g. Vertical multi-junction solar cells. In some examples, a cell can achieve a power density of 13.6 watts per cm², at a conversion efficiency of 24%. The cells can withstand and utilize the high intensity laser energy without damage and/or significant reduction in the conversion efficiency.

In some embodiments, posts and/or wireless power transmitters 420 can transmit power between one another. For example, as shown in the example of FIG. 4, wireless power transfer can be performed unidirectionally or bidirectionally between transmitters 420-1 and 420-2, as well as between transmitters 420-2 and 420-3, etc. Further, the posts can each deliver power to vehicles traveling proximate to and going by a respective post, and the system can hand off power delivery between posts to keep vehicles and aircraft receiving power as they get further from one post and closer to the next post. That is, the posts can be configured to provide power to a receiver within a proximate distance from the posts, and configured to hand off power delivery between the posts based at least in part on the distance of the vehicle from respective posts.

In some examples, vehicles and aircraft can traverse powered roads with minimal energy storage with powered parking lots on exits from the road. Other types of local vehicles could then tow them or load/unload them at each of a trip. In some embodiments, receivers can be authorized to receive power. In some instances vehicles cannot receive power because they are not equipped with a receiver. In other instances, vehicles will have receivers but not be authorized for power delivery. A system for identifying vehicles and aircraft that are authorized to receive power and aiming the transmission at the receiving system is contemplated. The system can include cameras and signaling systems within the receivers to guide aiming, and process authorization of the receivers. The vehicles and aircraft may have systems to block power from the transmission from entering the vehicle or aircraft itself. This may be, for example, insulation or faraday cage type structures.

Some embodiments can be integrated with the post guided autonomous vehicle navigation and control, and more particularly pertains to distributed sensing performed external to a vehicles. For example, vehicles could traverse a route driverless and without power storage. Electric vehicles without batteries or less battery capacity are much cheaper to manufacture. The system will save the energy lost from charging electric vehicle batteries and then discharging them. Some embodiments can utilize super-conducting materials to deliver power across the system. The installation of these materials alongside roads will then be amortized to deliver power into homes and offices located alongside those roads.

In some cases, the computing device or apparatus may include various components, such as one or more input devices, one or more output devices, one or more processors, one or more microprocessors, one or more microcomputers, one or more cameras, one or more sensors, and/or other component(s) that are configured to carry out the steps of processes described herein. In some examples, the computing device may include a display, one or more network interfaces configured to communicate and/or receive the data, any combination thereof, and/or other component(s). The one or more network interfaces may be configured to communicate and/or receive wired and/or wireless data, including data according to the 3G, 4G, 5G, and/or other cellular standard, data according to the WiFi (802.11x) standards, data according to the Bluetooth™ standard, data according to the Internet Protocol (IP) standard, and/or other types of data.

The components of the computing device may be implemented in circuitry. For example, the components may include and/or may be implemented using electronic circuits or other electronic hardware, which may include one or more programmable electronic circuits (e.g., microprocessors, graphics processing units (GPUs), digital signal processors (DSPs), central processing units (CPUs), and/or other suitable electronic circuits), and/or may include and/or be implemented using computer software, firmware, or any combination thereof, to perform the various operations described herein.

The processes described herein can include a sequence of operations that may be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations may be combined in any order and/or in parallel to implement the processes.

Additionally, the processes described herein, may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable or machine-readable storage medium, for example, in the form of a computer program comprising a plurality of instructions executable by one or more processors. The computer-readable or machine-readable storage medium may be non-transitory.

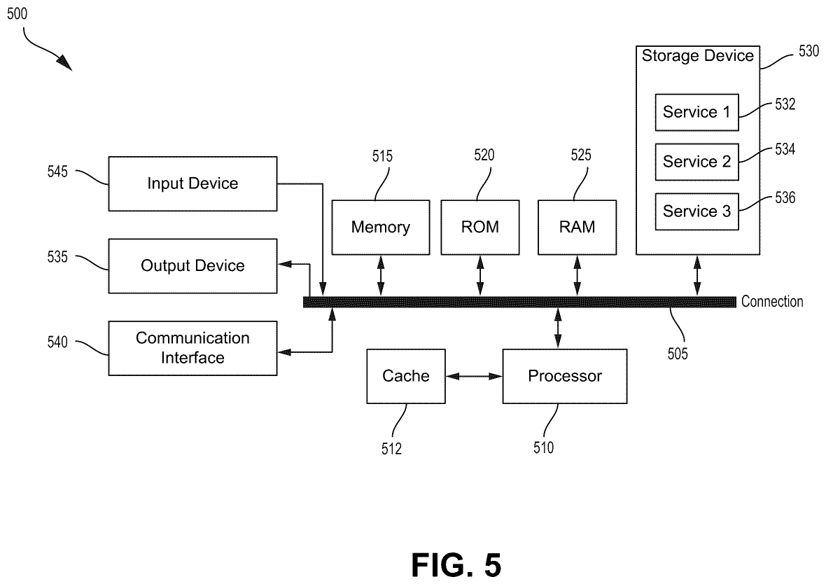

FIG. 5 is a diagram illustrating an example of a system for implementing certain aspects of the present technology. In particular, FIG. 5 illustrates an example of computing system 500, which may be for example any computing device making up internal computing system, a remote computing system, a camera, or any component thereof in which the components of the system are in communication with each other using connection 505. Connection 505 may be a physical connection using a bus, or a direct connection into processor 510, such as in a chipset architecture. Connection 505 may also be a virtual connection, networked connection, or logical connection.

In some aspects, computing system 500 is a distributed system in which the functions described in this disclosure may be distributed within a datacenter, multiple data centers, a peer network, etc. In some aspects, one or more of the described system components represents many such components each performing some or all of the function for which the component is described. In some aspects, the components may be physical or virtual devices.

Example system 500 includes at least one processing unit (CPU or processor) 510 and connection 505 that communicatively couples various system components including system memory 515, such as read-only memory (ROM) 520 and random-access memory (RAM) 525 to processor 510. Computing system 500 may include a cache 512 of high-speed memory connected directly with, in close proximity to, or integrated as part of processor 510.

Processor 510 may include any general-purpose processor and a hardware service or software service, such as services 532, 534, and 536 stored in storage device 530, configured to control processor 510 as well as a special-purpose processor where software instructions are incorporated into the actual processor design. Processor 510 may essentially be a completely self-contained computing system, containing multiple cores or processors, a bus, memory controller, cache, etc. A multi-core processor may be symmetric or asymmetric.

To enable user interaction, computing system 500 includes an input device 545, which may represent any number of input mechanisms, such as a microphone for speech, a touch-sensitive screen for gesture or graphical input, keyboard, mouse, motion input, speech, etc. Computing system 500 may also include output device 535, which may be one or more of a number of output mechanisms. In some instances, multimodal systems may enable a user to provide multiple types of input/output to communicate with computing system 500.

Computing system 500 may include communications interface 540, which may generally govern and manage the user input and system output. The communication interface may perform or facilitate receipt and/or transmission wired or wireless communications using wired and/or wireless transceivers, including those making use of an audio jack/plug, a microphone jack/plug, a universal serial bus (USB) port/plug, an Apple™ Lightning™ port/plug, an Ethernet port/plug, a fiber optic port/plug, a proprietary wired port/plug, 3G, 4G, 5G and/or other cellular data network wireless signal transfer, a Bluetooth™ wireless signal transfer, a Bluetooth™ low energy (BLE) wireless signal transfer, an IBEACON™ wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof. The communications interface 540 may also include one or more Global Navigation Satellite System (GNSS) receivers or transceivers that are used to determine a location of the computing system 500 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 530 may be a non-volatile and/or non-transitory and/or computer-readable memory device and may be a hard disk or other types of computer readable media which may store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (e.g., Level 1 (L1) cache, Level 2 (L2) cache, Level 3 (L3) cache, Level 4 (L4) cache, Level 5 (L5) cache, or other (L#) cache), resistive random-access memory (RRAM/ReRAM), phase change memory (PCM), spin transfer torque RAM (STT-RAM), another memory chip or cartridge, and/or a combination thereof.

The storage device 530 may include software services, servers, services, etc., that when the code that defines such software is executed by the processor 510, it causes the system to perform a function. In some aspects, a hardware service that performs a particular function may include the software component stored in a computer-readable medium in connection with the necessary hardware components, such as processor 510, connection 505, output device 535, etc., to carry out the function. The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data may be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc., may be passed, forwarded, or transmitted via any suitable means including memory sharing, message passing, token passing, network transmission, or the like.

Specific details are provided in the description above to provide a thorough understanding of the aspects and examples provided herein, but those skilled in the art will recognize that the application is not limited thereto. Thus, while illustrative aspects of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects may be utilized in any number of environments and applications beyond those described herein without departing from the broader scope of the specification. The specification and drawings are, accordingly, to be regarded as illustrative rather than restrictive. For the purposes of illustration, methods were described in a particular order. It should be appreciated that in alternate aspects, the methods may be performed in a different order than that described.

For clarity of explanation, in some instances the present technology may be presented as including individual functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

Individual aspects may be described above as a process or method which is depicted as a flowchart, a flow diagram, a data flow diagram, a structure diagram, or a block diagram. Although a flowchart may describe the operations as a sequential process, many of the operations may be performed in parallel or concurrently. In addition, the order of the operations may be re-arranged. A process is terminated when its operations are completed but could have additional steps not included in a figure. A process may correspond to a method, a function, a procedure, a subroutine, a subprogram, etc. When a process corresponds to a function, its termination may correspond to a return of the function to the calling function or the main function.

Processes and methods according to the above-described examples may be implemented using computer-executable instructions that are stored or otherwise available from computer-readable media. Such instructions may include, for example, instructions and data which cause or otherwise configure a general-purpose computer, special purpose computer, or a processing device to perform a certain function or group of functions. Portions of computer resources used may be accessible over a network. The computer executable instructions may be, for example, binaries, intermediate format instructions such as assembly language, firmware, source code. Examples of computer-readable media that may be used to store instructions, information used, and/or information created during methods according to described examples include magnetic or optical disks, flash memory, USB devices provided with non-volatile memory, networked storage devices, and so on.

In some aspects the computer-readable storage devices, mediums, and memories may include a cable or wireless signal containing a bitstream and the like. However, when mentioned, non-transitory computer-readable storage media expressly exclude media such as energy, carrier signals, electromagnetic waves, and signals per se.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof, in some cases depending in part on the particular application, in part on the desired design, in part on the corresponding technology, etc.

The various illustrative logical blocks, modules, and circuits described in connection with the aspects disclosed herein may be implemented or performed using hardware, software, firmware, middleware, microcode, hardware description languages, or any combination thereof, and may take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Examples of form factors include laptops, smart phones, mobile phones, tablet devices or other small form factor personal computers, personal digital assistants, rackmount devices, standalone devices, and so on. Functionality described herein also may be embodied in peripherals or add-in cards. Such functionality may also be implemented on a circuit board among different chips or different processes executing in a single device, by way of further example.

The instructions, media for conveying such instructions, computing resources for executing them, and other structures for supporting such computing resources are example means for providing the functions described in the disclosure.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods, algorithms, and/or operations described above. The computer-readable data storage medium may form part of a computer program product, which may include packaging materials. The computer-readable medium may comprise memory or data storage media, such as random-access memory (RAM) such as synchronous dynamic random-access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that may be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

One of ordinary skill will appreciate that the less than (“<”) and greater than (“>”) symbols or terminology used herein may be replaced with less than or equal to (“≤”) and greater than or equal to (“>”) symbols, respectively, without departing from the scope of this description.

Where components are described as being “configured to” perform certain operations, such configuration may be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” or “communicatively coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, A and B and C, or any duplicate information or data (e.g., A and A, B and B, C and C, A and A and B, and so on), or any other ordering, duplication, or combination of A, B, and C. The language “at least one of” a set and/or “one or more” of a set does not limit the set to the items listed in the set. For example, claim language reciting “at least one of A and B” or “at least one of A or B” may mean A, B, or A and B, and may additionally include items not listed in the set of A and B. The phrases “at least one” and “one or more” are used interchangeably herein.

Claim language or other language reciting “at least one processor configured to,” “at least one processor being configured to,” “one or more processors configured to,” “one or more processors being configured to,” or the like indicates that one processor or multiple processors (in any combination) can perform the associated operation(s). For example, claim language reciting “at least one processor configured to: X, Y, and Z” means a single processor can be used to perform operations X, Y, and Z; or that multiple processors are each tasked with a certain subset of operations X, Y, and Z such that together the multiple processors perform X, Y, and Z; or that a group of multiple processors work together to perform operations X, Y, and Z. In another example, claim language reciting “at least one processor configured to: X, Y, and Z” can mean that any single processor may only perform at least a subset of operations X, Y, and Z.

Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions.

Where reference is made to an entity (e.g., any entity or device described herein) performing functions or being configured to perform functions (e.g., steps of a method), the entity may be configured to cause one or more elements (individually or collectively) to perform the functions. The one or more components of the entity may include at least one memory, at least one processor, at least one communication interface, another component configured to perform one or more (or all) of the functions, and/or any combination thereof. Where reference to the entity performing functions, the entity may be configured to cause one component to perform all functions, or to cause more than one component to collectively perform the functions. When the entity is configured to cause more than one component to collectively perform the functions, each function need not be performed by each of those components (e.g., different functions may be performed by different components) and/or each function need not be performed in whole by only one component (e.g., different components may perform different sub-functions of a function).

Illustrative aspects of the disclosure include:

Aspect 1. A method comprising: detecting a vehicle traveling on a roadway, wherein the roadway is associated with a plurality of power distribution units for providing electrical power to authenticated vehicles; authenticating the vehicle to receive electrical power from one or more power distribution units of the plurality of power distribution units, wherein authentication is based on identifying information associated with the vehicle; based on successful authentication of the vehicle, energizing a selected one or more power distribution units of the plurality of power distribution units, wherein the selected one or more power distribution units are selected from the plurality of power distribution units as being nearest to the authenticated vehicle; providing electrical power from at least one of the energized power distribution units to the authenticated vehicle while the authenticated vehicle travels along the roadway; and de-energizing the selected one or more power distribution units based on detecting that a load associated with the authenticated vehicle is no longer present.

Aspect 2. The method of Aspect 1, wherein providing electrical power to the authenticated vehicle further comprises: analyzing electrical load information associated with a subset of currently energized power distribution units of the plurality of power distribution units, wherein the subset includes at least the one or more energized power distribution units associated with the authenticated vehicle; and controlling energization of at least a portion of the subset of currently energized power distribution units based on the analysis of the electrical load information.

Aspect 3. The method of Aspect 2, wherein controlling energization of at least a portion of the subset of currently energized power distribution units comprises: determining, based on the analysis of the electrical load information, that an energized power distribution unit coupled to one or multiple authorized vehicular loads is additionally coupled to at least one non-vehicular electrical load or non-authorized vehicular load; and based on the determination that the energized power distribution unit is coupled to a non-vehicular load or non-authorized vehicular load, de-energizing at least the energized power distribution unit coupled to the non-vehicular electrical load or non-authorized vehicular load.

Aspect 4. The method of Aspect 3, wherein determining that an energized power distribution unit is coupled to at least one non-vehicular load or non-authorized vehicular load is based on continuously or periodically monitoring the power distribution units to perform the analysis of the electrical load information.

Aspect 5. The method of Aspect 3, wherein determining that the energized power distribution unit is coupled to a non-vehicular electrical load is based on identifying one or more deviations between the current electrical load associated with the energized power distribution unit and a configured vehicular electrical load profile.

Aspect 6. The method of any of Aspects 1 to 5, further comprising: based on unsuccessful authentication of the vehicle, de-energizing or maintaining a de-energized state of one or more power distribution units nearby to the vehicle.

Aspect 7. The method of any of Aspects 1 to 6, wherein authenticating the vehicle is based on one or more of: detecting one or more visual indicators comprising the identifying information or receiving one or more radio frequency identification (RFID) signals indicative of the identifying information of the vehicle; or detecting, using an electrical load monitoring engine, a pattern of electrical pulses transmitted from the vehicle to a power distribution unit of the plurality of power distribution units.

Aspect 8. The method of Aspect 7, wherein the pattern of electrical pulses is indicative of one or more of the identifying information of the vehicle or an authentication code uniquely corresponding to the vehicle.

Aspect 9. The method of any of Aspects 1 to 8, wherein authenticating the vehicle includes one or more of: performing a public-key authentication exchange between an authentication engine and the vehicle; or receiving a respective unique authentication code from the vehicle for each time segment of a plurality of time segments, wherein each respective unique authentication code is mapped to a corresponding unique identity of the vehicle; or any of a large number of standard authentication techniques.

Aspect 10. The method of any of Aspects 1 to 8, wherein the plurality of power distribution units comprises a plurality of conductive rail segments.

Aspect 11. The method of Aspect 10, wherein the plurality of conductive rail segments are coupled to one another to form a continuous conductive rail disposed along a length of the roadway, or wherein the plurality of conductive rail segments are grouped into a plurality of subsets located discontinuously along a length of the roadway, each subset including one or more conductive rail segments of the plurality of conductive rail segments.

Aspect 12. The method of any of Aspects 1 to 11, wherein the plurality of power distribution units includes one or more wireless power distribution units configured to perform wireless power transmission to a vehicle on the roadway.

Aspect 13. The method of Aspect 12, wherein the one or more wireless power distribution units perform magnetic resonant wireless power transmission.

Aspect 14. An apparatus comprising: at least one memory; and at least one processor coupled to the at least one memory, the at least one processor configured to: detect a vehicle traveling on a roadway, wherein the roadway is associated with a plurality of power distribution units for providing electrical power to authenticated vehicles; authenticate the vehicle to receive electrical power from one or more power distribution units of the plurality of power distribution units, wherein authentication is based on identifying information associated with the vehicle; based on successful authentication of the vehicle, energize a selected one or more power distribution units of the plurality of power distribution units, wherein the selected one or more power distribution units are selected from the plurality of power distribution units as being nearest to the authenticated vehicle; provide electrical power from at least one of the energized power distribution units to the authenticated vehicle while the authenticated vehicle travels along the roadway; and de-energize the selected one or more power distribution units based on detecting that a load associated with the authenticated vehicle is no longer present.

Aspect 15. The apparatus of Aspect 14, wherein, to provide electrical power to the authenticated vehicle, the at least one processor is further configured to: analyze electrical load information associated with a subset of currently energized power distribution units of the plurality of power distribution units, wherein the subset includes at least the one or more energized power distribution units associated with the authenticated vehicle; and control energization of at least a portion of the subset of currently energized power distribution units based on the analysis of the electrical load information.

Aspect 16. The apparatus of Aspect 15, wherein, to control energization of at least a portion of the subset of currently energized power distribution units, the at least one processor is configured to: determine, based on the analysis of the electrical load information, that an energized power distribution unit coupled to one or multiple authorized vehicular loads is additionally coupled to at least one non-vehicular electrical load or non-authorized vehicular load; and based on the determination that the energized power distribution unit is coupled to a non-vehicular load or non-authorized vehicular load, de-energize at least the energized power distribution unit coupled to the non-vehicular electrical load or non-authorized vehicular load.

Aspect 17. The apparatus of Aspect 16, wherein determining that the energized power distribution unit is coupled to a non-vehicular electrical load is based on identifying one or more deviations between the current electrical load associated with the energized power distribution unit and a configured vehicular electrical load profile.

Aspect 18. The apparatus of any of Aspects 14 to 17, wherein the at least one processor is further configured to: based on unsuccessful authentication of the vehicle, de-energize or maintain a de-energized state of one or more power distribution units nearby to the vehicle.

Aspect 19. The apparatus of any of Aspects 14 to 18, wherein, to authenticate the vehicle, the at least one processor is configured to: detect one or more visual indicators comprising the identifying information; receive one or more radio frequency identification (RFID) signals indicative of the identifying information of the vehicle; or detect, using an electrical load monitoring engine, a pattern of electrical pulses transmitted from the vehicle to a power distribution unit of the plurality of power distribution units.

Aspect 20. The apparatus of Aspect 19, wherein the pattern of electrical pulses is indicative of one or more of the identifying information of the vehicle or an authentication code uniquely corresponding to the vehicle.

Aspect 21. The apparatus of any of Aspects 14 to 20, wherein the plurality of power distribution units comprises a plurality of conductive rail segments.

Aspect 22. The apparatus of Aspect 21, wherein the plurality of conductive rail segments are coupled to one another to form a continuous conductive rail disposed along a length of the roadway.

Aspect 23. The apparatus of any of Aspects 21 to 22, wherein the plurality of conductive rail segments are grouped into a plurality of subsets located discontinuously along a length of the roadway, each subset including one or more conductive rail segments of the plurality of conductive rail segments.

Aspect 24. The apparatus of any of Aspects 14 to 23, wherein the plurality of power distribution units includes one or more wireless power distribution units configured to perform wireless power transmission to a vehicle on the roadway.

Aspect 25. The apparatus of Aspect 24, wherein the one or more wireless power distribution units perform magnetic resonant wireless power transmission.

What is claimed is:

1. A method comprising:
detecting a vehicle traveling on a roadway, wherein the roadway is associated with a plurality of power distribution units for providing electrical power to authenticated vehicles;
authenticating the vehicle to receive electrical power from one or more power distribution units of the plurality of power distribution units, wherein authentication is based on identifying information associated with the vehicle;
based on successful authentication of the vehicle, energizing a selected one or more power distribution units of the plurality of power distribution units, wherein the selected one or more power distribution units are selected from the plurality of power distribution units as being nearest to the authenticated vehicle;
providing electrical power from at least one of the energized power distribution units to the authenticated vehicle while the authenticated vehicle travels along the roadway; and
de-energizing the selected one or more power distribution units based on detecting that a load associated with the authenticated vehicle is no longer present.

2. The method of claim 1, wherein providing electrical power to the authenticated vehicle further comprises:
analyzing electrical load information associated with a subset of currently energized power distribution units of the plurality of power distribution units, wherein the subset includes at least the one or more energized power distribution units associated with the authenticated vehicle; and
controlling energization of at least a portion of the subset of currently energized power distribution units based on the analysis of the electrical load information.

3. The method of claim 2, wherein controlling energization of at least a portion of the subset of currently energized power distribution units comprises:
determining, based on the analysis of the electrical load information, that an energized power distribution unit coupled to one or multiple authorized vehicular loads is additionally coupled to at least one non-vehicular electrical load or non-authorized vehicular load; and
based on the determination that the energized power distribution unit is coupled to a non-vehicular load or non-authorized vehicular load, de-energizing at least the energized power distribution unit coupled to the non-vehicular electrical load or non-authorized vehicular load.

4. The method of claim 3, wherein determining that an energized power distribution unit is coupled to at least one non-vehicular load or non-authorized vehicular load is based on continuously or periodically monitoring the power distribution units to perform the analysis of the electrical load information.

5. The method of claim 3, wherein determining that the energized power distribution unit is coupled to a non-vehicular electrical load is based on identifying one or more deviations between the current electrical load associated with the energized power distribution unit and a configured vehicular electrical load profile.

6. The method of claim 1, further comprising:
based on unsuccessful authentication of the vehicle, de-energizing or maintaining a de-energized state of one or more power distribution units nearby to the vehicle.

7. The method of claim 1, wherein authenticating the vehicle is based on one or more of:
detecting one or more visual indicators comprising the identifying information or receiving one or more radio frequency identification (RFID) signals indicative of the identifying information of the vehicle; or
detecting, using an electrical load monitoring engine, a pattern of electrical pulses transmitted from the vehicle to a power distribution unit of the plurality of power distribution units.

8. The method of claim 7, wherein the pattern of electrical pulses is indicative of one or more of the identifying information of the vehicle or an authentication code uniquely corresponding to the vehicle.

9. The method of claim 1, wherein authenticating the vehicle includes one or more of:
performing a public-key authentication exchange between an authentication engine and the vehicle; or
receiving a respective unique authentication code from the vehicle for each time segment of a plurality of time segments, wherein each respective unique authentication code is mapped to a corresponding unique identity of the vehicle.

10. The method of claim 1, wherein the plurality of power distribution units comprises a plurality of conductive rail segments.

11. The method of claim 10, wherein the plurality of conductive rail segments are grouped into a plurality of subsets located discontinuously along a length of the roadway, each subset including one or more conductive rail segments of the plurality of conductive rail segments.

12. The method of claim 1, wherein the plurality of power distribution units includes one or more wireless power distribution units configured to perform wireless power transmission to a vehicle on the roadway.

13. The method of claim 12, wherein the one or more wireless power distribution units perform magnetic resonant wireless power transmission.

14. An apparatus comprising:
at least one memory; and
at least one processor coupled to the at least one memory, the at least one processor configured to:
detect a vehicle traveling on a roadway, wherein the roadway is associated with a plurality of power distribution units for providing electrical power to authenticated vehicles;
authenticate the vehicle to receive electrical power from one or more power distribution units of the plurality of power distribution units, wherein authentication is based on identifying information associated with the vehicle;
based on successful authentication of the vehicle, energize a selected one or more power distribution units of the plurality of power distribution units, wherein the selected one or more power distribution units are selected from the plurality of power distribution units as being nearest to the authenticated vehicle;
provide electrical power from at least one of the energized power distribution units to the authenticated vehicle while the authenticated vehicle travels along the roadway; and
de-energize the selected one or more power distribution units based on detecting that a load associated with the authenticated vehicle is no longer present.

15. The apparatus of claim 14, wherein, to provide electrical power to the authenticated vehicle, the at least one processor is further configured to:
analyze electrical load information associated with a subset of currently energized power distribution units of the plurality of power distribution units, wherein the subset includes at least the one or more energized power distribution units associated with the authenticated vehicle; and
control energization of at least a portion of the subset of currently energized power distribution units based on the analysis of the electrical load information.

16. The apparatus of claim 15, wherein, to control energization of at least a portion of the subset of currently energized power distribution units, the at least one processor is configured to:
determine, based on the analysis of the electrical load information, that an energized power distribution unit coupled to one or multiple authorized vehicular loads is additionally coupled to at least one non-vehicular electrical load or non-authorized vehicular load; and
based on the determination that the energized power distribution unit is coupled to a non-vehicular load or non-authorized vehicular load, de-energize at least the energized power distribution unit coupled to the non-vehicular electrical load or non-authorized vehicular load.

17. The apparatus of claim 16, wherein determining that the energized power distribution unit is coupled to a non-vehicular electrical load is based on identifying one or more deviations between the current electrical load associated with the energized power distribution unit and a configured vehicular electrical load profile.

18. The apparatus of claim 14, wherein the at least one processor is further configured to:
based on unsuccessful authentication of the vehicle, de-energize or maintain a de-energized state of one or more power distribution units nearby to the vehicle.

19. The apparatus of claim 14, wherein, to authenticate the vehicle, the at least one processor is configured to:
detect one or more visual indicators comprising the identifying information;
receive one or more radio frequency identification (RFID) signals indicative of the identifying information of the vehicle; or
detect, using an electrical load monitoring engine, a pattern of electrical pulses transmitted from the vehicle to a power distribution unit of the plurality of power distribution units.

20. The apparatus of claim 19, wherein the pattern of electrical pulses is indicative of one or more of the identifying information of the vehicle or an authentication code uniquely corresponding to the vehicle.
